(19) United States
(12) Patent Application Publication
(10) Pub. No.: US 2026/0109789 A1
(43) Pub. Date: Apr. 23, 2026

(54) DEVULCANIZED RUBBER, PROCESS FOR PRODUCING DEVULCANIZED RUBBER, AND USE THEREOF

(71) Applicant: Evonik Operations GmbH, Essen (DE)

(72) Inventors: Roland Krafczyk, Rheinfelden (DE); Christian Mani, Bochum (DE); Rupert Schnell, Worms (DE); Alexander Paasche, Haltern am See (DE)

(73) Assignee: Evonik Operations GmbH, Essen (DE)

(21) Appl. No.: 19/122,790

(22) PCT Filed: Oct. 17, 2023
(86) PCT No.: PCT/EP2023/078721

§ 371 Date: Apr. 21, 2025

(30) Foreign Application Priority Data
Oct. 27, 2022 (EP) 22204116.2

(51) Int. Cl. C08C 19/00; C08L 17/00

(52) U.S. Cl. CPC C08C 19/085; C08L 17/00

(57) ABSTRACT

Subject matter of the invention is a devulcanized rubber having a TAVP of <2.7. The devulcanized rubber is produced by comminuting vulcanized rubber and reacting it at temperatures between 140-180° C. for 4 to 7 minutes with vinylsilane as devulcanizing agent and with a concentration of vinylsilane of 4 to 6 wt %, based on the vulcanized rubber, and with an energy input during the reaction of >140 kNm.

The invention relates to devulcanized rubber, to processes for producing it and to its use.

An objective of tyremakers is to increase the proportion of recycled rubber in tyremaking. Granulated scrap tyres, MRP (micronized rubber powder) and granules from old tyre treads can be reused only conditionally and to a very small extent, in order not to detract significantly from the performance of the tyres. The reuse of granulated scrap tyres is limited, since the rubber particles involved have already been sulfur-crosslinked (vulcanized), whereas re-use requires unvulcanized particles having significantly lower viscosities.

It is known that disulfides such as diphenyl disulfide (DPDS) (Asaro, L.; Gratton, M.; Seghar, S.; Hocine, N. A. Recycling of rubber wastes by devulcanization. Resour. Conserv. Recycl. 2018, 133, 250-262; Edwards, D. W., Danon, B., van der Gryp, P., Georgens, J. F., 2016. Quantifying and comparing the selectivity for crosslink scission in mechanical and mechanochemical devulcanization processes. J. Appl. Polym. Sci. 133 (37), 1-10), dibutyl disulfides (DBDS), dibenzamidodiphenyl sulfides (DBD) and polysulfides too such as triethoxysilylpropyl tetrasulfides (TESPT) (U.S. Pat. No. 9,683,088 B2) are capable of devulcanizing vulcanized rubber mixtures. In devulcanization, which may take place at elevated temperatures in a kneader or extruder, for example, the sulfur bridges are opened thermally and/or radically and are prevented from recombining by grafting with scavengers such as disulfides. This produces chemically devulcanized rubber particles (Saiwari, S., Dierkes, W. K., Noordermeer, J. W., 2018. Recycling of individual Waste rubber, in: Rubber Recycling: Challenges and Developments, 1st edition, Royal Society of Chemistry, pp. 186-232).

U.S. Pat. No. 5,258,413 discloses continuous devulcanization of vulcanized elastomers by ultrasound.

Furthermore, U.S. Pat. No. 11,453,758 B2 discloses a process for continuous production of devulcanized rubber by means of a multistage screw extruder.

A disadvantage affecting the use of the common devulcanizing agents is that the rubber, under thermal load, is additionally degraded by opening of C—C bonds. As a result of the molar mass reduced in this way, rubber particles devulcanized with disulfides, when reused, exhibit significantly lower tensile strain properties than newly produced rubber.

It is an object of the present invention to provide devulcanized rubber in which as few C—C bonds are possible are destroyed and consequently on re-use in rubber mixtures the tensile strain behaviour is improved relative to the prior art.

At temperatures below the thermal degradation of the polymers, the value of the total area of visible particles (TAVP) may be employed as a measure of the selectivity of the devulcanization. The TAVP is determined by compounding the devulcanized rubber with a so-called white rubber mixture. The TAVP here describes the size of the total area of the visible rubber particles after the devulcanization. The more selective the devulcanization has been, the smaller the total area of the visible particles and the smaller, consequently, the resultant TAVP value.

One subject of the invention is devulcanized rubber which is characterized in that the TAVP is <2.7, preferably 0.8-1.8.

The devulcanized rubber of the invention may comprise butadiene and/or styrene structural units. The devulcanized rubber may preferably comprise SSBR and BR structural units, and the SSBR and BR may be unfunctionalized or functionalized, for example with epoxy, silyl or amine groups.

The devulcanized rubber of the invention may contain 10-200 phr, preferably 20-120 phr, more preferably 30-100 phr of silica.

The devulcanized rubber of the invention may have a (network breakdown) value NWB of >50%.

The devulcanized rubber of the invention may have an fₛₒₗ of ≥12.0%.

The devulcanized rubber of the invention may have a tensile strength value TS of >7.8 MPa.

A further subject of the invention is a process for producing the devulcanized rubber of the invention, which is characterized in that vulcanized rubber is comminuted and reacted with vinylsilane as devulcanizing agent at temperatures between 140-180° C., preferably between 150-160° C., for 4 to 7 minutes with a concentration of devulcanizing agent of 4 to 6 wt %, based on the vulcanized rubber, and with an energy input during the reaction of >130 kNm, preferably 150-180 kNm.

The vulcanized rubber may be comminuted by means of waterjet, cryogenic or ambient-mechanical milling. The particle size of the comminuted rubber may be 50 μm to 5000 μm, preferably 50 μm to 2000 μm, more preferably 75 μm to 1500 μm.

The vulcanized rubber may derive from treads of scrap tyres or from the entire comminuted scrap tyre.

Before the vinylsilane is added, the comminuted vulcanized rubber may be swollen with oil, preferably distilled aromatic oil.

The vinylsilane may be a silane of the formula I

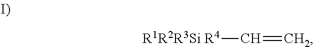

where R¹, R² and R³ independently of one another are H, C1-C8 alkyl, C1-C8 alkoxy or phenoxy and R⁴ is a divalent aliphatic and/or aromatic, unbranched or branched hydrocarbon group or a bond.

The vinylsilane may preferably be a silane of the formula I where R¹, R² and R³ are C1-C8 alkoxy.

The vinylsilane may more preferably be a vinyltrialkoxysilane, very preferably vinyltriethoxysilane.

The vinylsilane may be an oligomer of vinylsilanes and/or cooligomer of vinyl- with alkylsilanes.

The vinylsilane may be used in amounts of 1-20 wt %, preferably 3-10 wt %, based on the vulcanized rubber used.

The vinylsilane may be used together with peroxides. Peroxides used may comprise dicumyl peroxide and/or benzoyl peroxide. Preferably it is possible to use dicumyl peroxide, for example DYNASYLAN® SILFIN 301 (mixture of vinyltriethoxysilane and dicumyl peroxide) from Evonik Industries AG.

The peroxide may be used in amounts of 1-20 wt %, preferably 1-10 wt %, based on the vinylsilane.

The reaction (devulcanization) may be carried out in a kneader, for example a Brabender mixer, E kneader or N kneader, or in an extruder, for example in a single-screw extruder, twin-screw extruder or planetary roller extruder.

In the process of the invention, it is preferably possible to comminute vulcanized rubber and react it with vinyltriethoxysilane and peroxide at temperatures between 140-180° C.

In the process of the invention it is possible more preferably to comminute vulcanized rubber from scrap tyres and react it with vinyltriethoxysilane and dicumyl peroxide at temperatures between 140-180° C.

A further subject of the invention is the use of vinylsilanes, optionally with addition of peroxides, for the devulcanization of vulcanizates.

A further subject of the invention is the use of the devulcanized rubber of the invention as raw material in vulcanized rubber mixtures.

A further subject of the invention are vulcanized rubber mixtures comprising the devulcanized rubber of the invention.

The invention is advantageous in that the proportion of degraded polymer chains is significantly reduced by comparison with devulcanizing reagents from the prior art and consequently, when the devulcanized rubber is reused in new rubber mixtures, the tensile strain properties are significantly improved, and so the proportion of devulcanized rubber in new rubber mixtures can be increased.

### Measurement Methods

The following methods are employed for characterization:

### Tensile Strain Tests

The tensile strain properties are carried out after the revulcanization step on a Z010 tensile strength testing machine from Zwich Roell GmbH & Co. KG in accordance with ASTM D412-16e1.

### Determination of Mooney Viscosity

Viscosity measurements are carried out on an MV 2000 VS viscometer from Alpha Technologies GmbH in accordance with ASTM D1646-19a.

### Determination of Crosslinking Density

The crosslinking density of the devulcanized rubber is determined in accordance with ASTM D6814-02 on the basis of the Flory-Rehner equation. For this the devulcanized rubber is first dried overnight at 80° C. in a Heraeus-brand oven and weighed after cooling to give the parameter m1. The rubber sample is then wrapped in a Whatman-brand filter paper and placed in a flask filled with 500 ml of acetone. The flask is subsequently attached to a Soxhlet apparatus and heated at 56° C. for 48 hours. After cooling, the rubber sample is again dried overnight in the oven at 80° C., the filter paper is removed, and the dried rubber sample is weighed to give the parameter m2. The rubber sample subsequently is again wrapped in filter paper and placed in a flask filled with 500 ml of tetrahydrofuran (THF). The flask is attached to a Soxhlet apparatus and heated at 66° C. for 72 hours. After cooling, the rubber sample is again dried overnight in the oven at 80° C., the filter paper is removed, and the dried rubber sample is weighed to give the parameter m3. The rubber sample is thereafter placed into a 50 ml vial, 40 ml of toluene are added, and the sample is left to swell for at least 4 days until equilibrium is reached. After swelling, the rubber sample is taken from the toluene solution and weighed again to give the parameter m4.

The proportion of the sol fraction is calculated as follows:

$${f}_{sol} = \frac{m 1 - m 3}{m 1} \times 100.$$

The network density v is subsequently calculated with the Flory-Rehner equation:

$$v = \frac{{f}_{p} + χ \times {f}_{p}^{2} + ln ( 1 - {f}_{p} )}{{v}_{ms} \times ( 0.5 {f}_{p} - \sqrt[3]{{f}_{p}} )} .$$

In this equation, vₘₛ is the molar volume of the swelling agent and x is the interaction parameter, which here is 0.39. The volume fraction fₚ is calculated as follows:

$${f}_{p} = \frac{m 1}{m 1 + {m}_{s} \times \frac{{ρ}_{p}}{{ρ}_{s}}} .$$

In this equation, ρₚ is the density of the rubber sample and ρₛ is the density of the swelling agent. The mass of the swelling agent, mₛ, is determined as follows: mₛ=m₄-m₁.

The proportion of network breakdown, NWB, is calculated as the difference between the network density of the vulcanized rubber (v₁) and the network density of the devulcanized rubber sample (v₂):

$$N W B = ( 1 - \frac{{v}_{2}}{{v}_{1}} ) \times 100$$

(Verbruggen, M., 2007. Devulcanization of EPDM rubber: a mechanistic study into a successful method, pp. 29-33, PHD thesis, University of Twente, The Netherlands).

### TAVP—White Rubber Analysis

The so-called white rubber analysis can be used to determine the total area of visible particles (TAVP). For this it is necessary first to prepare a specimen. The TiO₂ and MBTS (mercaptobenzothiazolesulfenamide) substances used for this purpose are obtained from Sigma Aldrich.

To prepare the specimen, in an initial compounding step, 100 phr of the polybutadiene rubber CB24 are mixed with 85 phr of TiO₂, 5 phr of ZnO and 1 phr of stearic acid and the mixture is then processed at 60° C. for four minutes with a stirring speed of 100 rpm in a Brabender internal mixer. The resultant white rubber mixture is left to stand at room temperature for a day. The next day, 171 phr of the white rubber mixture are mixed with 5 phr of sulfur and 2.5 phr of MBTS and the mixture is vulcanized at 60° C. and 100 rpm for two minutes in the Brabender internal mixer.

The white rubber mixture is subsequently mixed with the devulcanized rubber in a ratio of 90:10 and masticated at RT for three minutes in a double-roll mill. This rubber mixture is then vulcanized in a Wickert press at 170° C. for ten minutes and processed to give discs 5 mm thick with a radius of 50 mm. The vulcanized rubber is subsequently cooled in liquid nitrogen for 15 minutes and the surface is polished with abrasive paper (120 grade).

For determining the TAVP, the specimen is investigated using the Keyence-brand VHX 5000 3D digital microscope and evaluated with the aid of the on-board ImageJ software. The settings made on the digital microscope for this purpose are as follows:
Parameter: condition
Imaging mode: 2D stitching
Stitching: 5×6
Zoom: 20×-30×
Light: full-ring
Cover area: round
Base to lens angle: 90°

### EXAMPLES

### Model Compound

The devulcanization experiments and characterization of materials below are set out and elucidated using a model compound by way of example. The devulcanization experiments and characterization of material were conducted at the University of Twente in the research groups of Prof. Dr Blume and Dr Dierkes. The production of the model compound is guided by the standard formulation for car tyre treads according to Table 1.

TABLE 1

| Constituents | Name | Amount (phr) |
|---|---|---|
| Styrene-butadiene rubber | Sprintan | 70 |
| (SBR) | SLR 4601 | |
| Polybutadiene rubber (BR) | CB 24 | 30 |
| Silica (SiO₂) | ULTRASIL ® 7000 GR | 80 |
| Silane | Si 266 ™ | 5.8 |
| Zinc oxide | ZnO | 3 |
| Stearic acid | Stearic acid | 2 |
| TDAE oil | Vivatec | 25 |
| Sulfur | Sulfur | 1.5 |
| CBS | Santocure CBS | 1.7 |
| DPG | Perkacit DPG | 2.5 |

The Sprintan SLR 4601 was supplied by Trinseo, the polybutadiene rubber CB 24 by Arlanxeo, ULTRASIL® 7000 GR by Evonik, the zinc oxide and stearic acid and the sulfur by Merck, the TDAE oil Vivatec 500 by Hansen & Rosenthal; the accelerators Santocure CBS and Perkacit DPG were supplied by Flexsys, and the Si 266™ by Evonik.

The model compound was produced using a Brabender-brand 350S internal mixer having a capacity of 390 m₁, and a two-roll mill from Schwabenthan.

### Production of the Model Compound:

First of all the polymers SBR (70 phr) and BR (30 phr) were placed into the internal mixer and masticated at 80° C. at a speed of 70 rpm for one minute. Subsequently ULTRASIL® 7000 GR (40 phr) and Si 266™ (2.9 phr) were added and the mixture was kneaded for a further minute under the reaction conditions above. Thereafter the following constituents were added: 40 phr of ULTRASIL® 7000 GR, 2.9 phr of Si 266™, 3 phr of ZnO, 2 phr of stearic acid and 25 phr of TDAE oil. This mixture was initially kneaded for one minute at 140° C. The temperature was then increased to 145° C. and the mixture was mixed at 70 rpm for a further four minutes. This mixture was then left to stand overnight at room temperature (RT). The next day, the mixture was transferred to the two-roll mill and processed at RT. The roll speed of the front roll was set to 20 rpm and that of the rear roll to 25 rpm, with a roll nip of 1.5-2.0 mm. After a mastication time of two minutes, the crosslinking system, consisting of 1.5 phr of sulfur, 1.7 phr of CBS and 2.5 phr of DPG, was added and the mixture was processed for a further seven minutes. The resulting mixture was subsequently pressed to give plates 2 mm thick at a temperature of 160° C. with a vulcanization time of t-95 (i.e. 1305 seconds).

### Devulcanization of the Model Compound:

In the next step, the vulcanized material was initially placed in liquid nitrogen for 3 minutes and then milled in a Fritsch laboratory mill to a mesh size of 0.7 mm.

The subsequent devulcanization was carried out in a 50 cm³ internal mixer from Brabender, which is equipped with a tangential and counter-rotating rotor drive. The system in which the vulcanization was carried out included a press from Wickert.

As a preliminary to the devulcanization of the model compound, the milled material was first swollen with TDAE oil as follows: 400 g of the milled model compound were admixed with 20 g (5 wt %) of TDAE oil and stirred with a spoon for 10 minutes at room temperature. This mixture was left to stand at RT overnight and on the next day was swollen with the devulcanizing agent. For this, 105 g of the swollen compound (containing 100 g of milled model compound+5 g of TDAE oil) were admixed with the corresponding concentration of the devulcanizing agent (wt % based on the milled model compound). The mixture was stirred with a spoon for 10 minutes at RT and then left to stand at room temperature overnight. The model compound was subsequently placed into the internal mixer and devulcanized at an internal-mixer temperature T (° C.) and a rotor speed R (rpm) for a reaction time t (min). After the devulcanization step, the devulcanized rubber was transferred to the double-roll mill and processed at RT. Here, the roll speed of the front roll was set at 20 rpm and that of the rear roll at 25 rpm, with a roll nip of 0.2 mm-1.0 mm being selected.

### Revulcanization of the Model Compound

For the revulcanization of the model compound, the devulcanized rubber was processed in the double-roll mill. The roll speed of the front roll was set at 20 rpm, that of the rear roll at 25 rpm, and the roll nips were adjusted to 0.5 mm-1.0 mm. The devulcanized rubber was initially masticated at RT for one minute, after which 4 g of ZnO and 2 g of stearic acid were added. The mixture was again masticated at RT for two minutes. Then 1.5 g of sulfur and 1.7 g of CBS were added and the mixture was masticated for four minutes more. The mixture was left to stand overnight at RT and on the next day was vulcanized at 160° C. and pressed to give plates 2 mm thick.

In accordance with the protocol stated above, the following devulcanizates (or devulcanized rubber samples) were produced with the various devulcanizing agents (DA) under the following conditions and tested (Table 2).

TABLE 2

| | | Reaction conditions | | | | | | | | |
|---|---|---|---|---|---|---|---|---|---|---|
| | | T | DT | C | TEI | TAVP | TS | EAB | NWB | fₛₒₗ |
| # | DA | (° C.) | (min) | (%) | (kNm) | (%) | (MPa) | (%) | (%) | (%) |
| 1 | SILFIN | 130 | 4 | 5 | 165 | 3.22 | 7.6 | 91 | 37 | 7.6 |
| 2 | SILFIN | 140 | 4 | 5 | 165 | 2.45 | 8.6 | 108 | 42 | 8.2 |
| 3 | SILFIN | 150 | 4 | 5 | 165 | 1.9 | 9.2 | 111 | 46 | 10.4 |
| 4 | SILFIN | 155 | 4 | 5 | 165 | 1.72 | 9.2 | 110 | 51 | 11.3 |
| 5 | SILFIN | 160 | 4 | 5 | 165 | 1.66 | 9.3 | 106 | 55 | 12.1 |
| 6 | SILFIN | 170 | 4 | 5 | 165 | 1.29 | 9.4 | 94 | 59 | 14.6 |
| 7 | SILFIN | 180 | 4 | 5 | 165 | 0.93 | 8.9 | 88 | 63 | 16.7 |
| 8 | SILFIN | 155 | 5 | 5 | 165 | 1.66 | 9.3 | 109 | 52 | 12 |
| 9 | SILFIN | 155 | 6 | 5 | 165 | 1 | 9.4 | 113 | 54 | 13.6 |
| 10 | SILFIN | 155 | 7 | 5 | 165 | 0.55 | 9.1 | 103 | 57 | 15.3 |
| 11 | SILFIN | 155 | 6 | 5 | 45 | 6.21 | 5.3 | 42 | 22 | 4.7 |
| 12 | SILFIN | 155 | 6 | 5 | 75 | 4.99 | 6.6 | 67 | 31 | 6.4 |
| 13 | SILFIN | 155 | 6 | 5 | 105 | 3.25 | 7.9 | 82 | 38 | 8.5 |
| 14 | SILFIN | 155 | 6 | 5 | 135 | 2.28 | 8.8 | 106 | 45 | 10.5 |
| 15 | SILFIN | 155 | 6 | 4 | 165 | 1.14 | 9.3 | 106 | 51 | 13.5 |
| 16 | SILFIN | 155 | 6 | 6 | 165 | 0.8 | 9.4 | 108 | 57 | 11.9 |
| 17 | VTEO | 130 | 4 | 5 | 105 | 5.3 | 5.5 | 41 | — | — |
| 18 | VTEO | 130 | 4 | 5 | 135 | 4.1 | 6.7 | 48 | — | — |
| 19 | VTEO | 130 | 4 | 5 | 165 | 3.7 | 7.2 | 55 | — | — |
| 20 | VTEO | 140 | 4 | 5 | 165 | 2.4 | 8.5 | 88 | — | — |
| 21 | VTEO | 140 | 6 | 5 | 165 | 1.91 | 9 | 95 | 40 | 8.5 |
| 22 | VTEO | 140 | 6 | 3 | 165 | 3.28 | 7.5 | 63 | — | — |
| 23 | VTEO | 140 | 6 | 4 | 165 | 2.58 | 8.2 | 76 | — | — |
| 24 | VTEO | 140 | 6 | 6 | 165 | 1.58 | 9 | 88 | — | — |
| 25 | VTEO | 160 | 6 | 5 | 165 | 1.94 | 8.9 | 91 | 44 | 11.4 |
| 26 | VTEO | 170 | 6 | 5 | 165 | 1.85 | 8.3 | 76 | — | — |
| 27 | VTEO | 180 | 6 | 5 | 165 | 1.47 | 7.9 | 68 | — | — |
| 28 | TESPT | 130 | 4 | 5 | 105 | 5.64 | 4.7 | 33 | — | — |
| 29 | TESPT | 130 | 4 | 5 | 135 | 4.92 | 5.5 | 36 | — | — |
| 30 | TESPT | 130 | 4 | 5 | 165 | 4.3 | 6.5 | 42 | — | — |
| 31 | TESPT | 140 | 4 | 5 | 165 | 3.83 | 7.4 | 72 | 32 | 6.6 |
| 32 | TESPT | 140 | 6 | 5 | 165 | 3.52 | 7.5 | 69 | 38 | 8.2 |
| 33 | TESPT | 160 | 6 | 5 | 165 | 3.77 | 7.4 | 65 | 45 | 10.2 |
| 34 | TESPT | 160 | 6 | 5 | 165 | 4.17 | 6.9 | 63 | 49 | 12.5 |
| 35 | TESPT | 170 | 6 | 5 | 165 | 3.84 | 7.1 | 76 | — | — |
| 36 | TESPT | 180 | 6 | 5 | 165 | 2.98 | 7.7 | 79 | — | — |
| 37 | TESPT | 180 | 6 | 3 | 165 | 4.38 | 6.1 | 43 | — | — |
| 38 | TESPT | 180 | 6 | 4 | 165 | 3.48 | 7.3 | 67 | — | — |
| 39 | DPDS | 140 | 4 | 5 | 165 | 5.16 | 4.7 | 28 | — | — |
| 40 | DPDS | 140 | 5 | 5 | 165 | 4.52 | 5.6 | 31 | — | — |
| 41 | DPDS | 140 | 6 | 5 | 165 | 3.86 | 6.9 | 42 | — | — |
| 42 | DPDS | 160 | 6 | 5 | 165 | 3.16 | 7.1 | 58 | — | — |
| 43 | DPDS | 170 | 6 | 5 | 165 | 2.96 | 7.2 | 62 | — | — |
| 44 | DPDS | 180 | 6 | 5 | 165 | 2.89 | 6.9 | 51 | — | — |
| 45 | DPDS | 170 | 6 | 3 | 165 | 3.7 | 6.5 | 39 | — | — |
| 46 | DPDS | 170 | 6 | 4 | 165 | 3.35 | 6.8 | 54 | — | — |
| 47 | DPDS | 170 | 6 | 6 | 165 | 2.79 | 7 | 68 | — | — |

T = temperature;
DT = dwell time;
C = DA concentration;
TEI = total energy input;
TAVP = total area of visible particles;
TS = tensile strength;
EAB = elongation at break;
NWB = network breakdown;
fₛₒₗ = sol fraction

The devulcanized rubber of the invention is characterized in that it possesses a TAVP of less than 2.7%. The TAVP can be controlled through, among others, the operating conditions of temperature (T), dwell time in the internal mixer (DT), devulcanizing agent concentration (C), and the total energy input (TEI) in the internal mixer. In principle it is the case that the lower the TAVP, the more selective and efficient the devulcanization. As a yardstick for the quality of the devulcanization it is likewise possible to employ the degree of network breakdown (NWB). A higher network breakdown is considered here to be desirable. As the devulcanization temperature goes up, the TAVP drops and the NWB increases. However, the TAVP is meaningful only at temperatures below the thermal degradation of the polymer. Below the degradation temperature of the polymer, a low TAVP leads to an improvement in the mechanical properties of the revulcanized material, as may be observed from an increasing tensile strength (TS) and tensile elongation (EAB). At temperatures above the thermal degradation of the polymer, a low TAVP is attributable to the polymer degradation and not to the selective elimination of sulfur bridges. In this temperature range it is the case that the tensile strength (TS) and tensile elongation (EAB) of the revulcanized materials become poorer, i.e. lower, in spite of low TAVP values.

From the overview table it is apparent that SILFIN (DYNASYLAN® SILFIN 301) and VTEO (vinyltriethoxysilane), at temperatures between 140-180° C., dwell times between 4-7 min, devulcanizing agent concentrations between 4-6 wt % and energy inputs above 130 kNm, furnish the devulcanized rubber of the invention.

Temperatures below 140° C. (see Table 2, #1, 17-19) result in high TAVP values, this being attributable to insufficient devulcanization. The opening of sulfur bridges and the radical reactions proceed more effectively beyond 140° C. Beyond a temperature of around 180° C., the tensile strength drops; this may be explained by the onset of the thermal degradation of the polymer (see Table 2, #7, 27). Above the thermal degradation temperature, the mechanical properties of TS and EAB drop as TAVP values become smaller (see Table 2, #7). The influence of the total energy input (TEI) on the selectivity of the devulcanization is apparent from entries including Table 2, #9, 11-14. This indicates that the selectivity of the devulcanization likewise rises with increasing energy input of the internal mixer.

The devulcanization experiments conducted with the devulcanizing agents TESPT and DPDS, respectively (see Table 2, #28-47), show that the devulcanized rubber of the invention cannot be achieved with the prior art.

1. A devulcanized rubber obtained by reaction of vulcanized rubber with vinylsilane,
wherein a Total Area of Visible Particles (TAVP) of the devulcanized rubber is <2.7%.

2. The devulcanized rubber according to claim 1, comprising:
butadiene and/or styrene structural units.

3. The devulcanized rubber according to claim 1, which contains 10-200 phr of silica.

4. The devulcanized rubber according to claim 1, which has an NWB of >50%.

5. The devulcanized rubber according to claim 1, which has an fₛₒₗ of ≥12.0%.

6. Process A process for producing the devulcanized rubber according to claim 1, comprising:
comminuting and reacting the vulcanized rubber with vinylsilane as devulcanizing agent at temperatures between 140-180° C. for 4 to 7 minutes with a concentration of devulcanizing agent of 4 to 6 wt %, based on the vulcanized rubber, and with an energy input during the reaction of >140 kNm.

7. The process for producing the devulcanized rubber according to claim 6, comprising:
comminuting the vulcanized rubber by waterjet, cryogenic or ambient-mechanical milling.

8. The process for producing the devulcanized rubber according to claim 6, comprising:
swelling, before adding the vinylsilane, the comminuted vulcanized rubber with oil.

9. The process for producing the devulcanized rubber according to claim 6, wherein the vinylsilane comprises a vinyltrialkoxysilane.

10. The process for producing the devulcanized rubber according to claim 6, comprising:
the vinylsilane in amounts of 1-20 wt %, based on the vulcanized rubber.

11. The process for producing the devulcanized rubber according to claim 6, wherein the vinylsilane is used together with peroxides.

12. The process for producing the devulcanized rubber according to claim 6, wherein peroxides comprise dicumyl peroxide and/or benzoyl peroxide.

13. The process for producing the devulcanized rubber according to claim 6, comprising:
the peroxides in amounts of 1-20 wt %, based on the vinylsilane.

14. The process for producing the devulcanized rubber according to claim 6, comprising:
comminuting vulcanized rubber from scrap tyres, and
swelling the comminuted rubber with oil, and
devulcanizing the comminuted rubber with vinyltriethoxysilane and dicumyl peroxide.

15-16. (canceled)

17. A vulcanized rubber mixture, comprising:
the devulcanized rubber according to claim 1.

18. The devulcanized rubber according to claim 1, which contains 20-120 phr of silica.

19. The process for producing the devulcanized rubber according to claim 6, wherein the vinylsilane comprises vinyltriethoxysilane.

20. The process for producing the devulcanized rubber according to claim 6, comprising:
the vinylsilane in amounts of 3-10 wt %, based on the vulcanized rubber.

21. The process for producing the devulcanized rubber according to claim 6, comprising:
the peroxides in amounts of 1-10 wt %, based on the vinylsilane.
